(19) United States
(12) Patent Application Publication
(10) Pub. No.: US 2008/0042486 A1
(43) Pub. Date: Feb. 21, 2008

(54) Method for Producing a Balance Weight for a Vehicle Wheel and the Thus Obtained Balance Weight

(75) Inventor: Thierry Malbos, Montfaucon (FR)

Correspondence Address: EGBERT LAW OFFICES, 412 MAIN STREET, 7TH FLOOR, HOUSTON, TX, 77002, US

(73) Assignee: Zenith Precision, Societe par actions simplifiee, Besancon (FR)

(21) Appl. No.: 11/720,332

(22) PCT Filed: Nov. 30, 2005
(86) PCT No.: PCT/FR05/51003

§ 371 Date: Jun. 20, 2007

(30) Foreign Application Priority Data
Dec. 3, 2004 (FR) 0452857

(51) Int. Cl. F16F 15/32; B22D 19/04; B22D 19/16

(52) U.S. Cl. 301/5.21; 164/112; 164/98

(57) ABSTRACT

The method for producing a balance weight for a vehicle wheel and the obtained weight. The method includes injection-molding a weight of a zinc alloy and fixing the weight to a wheel rim by a clip. The inventive method involves producing a cavity in the thickness of the weight or receiving a part of the clip, in arranging the cavity in such a way that it makes it possible to place and retain the introducible part of the clip and in introducing and fixing the above therein.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES To A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention relates to the field of the production of automobile equipment and its object is a method for producing a balance weight for vehicle wheels consisting of a weight aimed at being fixed to the rim of a wheel by means of a clip.

The invention also relates to the balance weights resulting from the implementation of said method.

2. Description of Related Art Including Information Disclosed Under 37 CFR 1.97 and 37 CFR 1.98.

Achieving a perfect balance of the wheels is a fundamental operation for all the types of vehicles, aimed at both preventing premature wear of the suspension organs, the steering organs, and the tires, and avoiding driving discomfort.

The balancing of the wheels is also an operation impossible to avoid, because mounting a new tire onto a wheel is obviously relevant to its balance, whether it is because of the eccentricity of the tires, a radial or lateral eccentricity of the rim, or an inadequate position of the valve. On the other hand, the normal use of a vehicle and the slightest irregularity of wear of the tires resulting from some abrupt braking operations also change the balance of the wheels.

Traditionally, the balancing of a wheel consists, inter alia, of obtaining a static balance through one or more balance weights, arranged between the rim and the tire, in contrast to the unbalanced weight, by means of clips.

Until recently, it was usual to use balance weights made out of lead, such as those described in French Patent No. 1,237,596, French Patent No. 31 18 222 and U.S. Pat. No. 2,221,747. At present, however, manufacturers prefer to use other materials, namely materials more compatible with the most recent regulatory requirements at the environmental level. The use of materials other than lead now raises new problems and necessitates, in addition, the development of adapted production methods.

Several publications already deal with balance weights made out of materials other than lead, and their production methods.

European Patent Application No. 1.113.188, for example, discloses a balance weight made by sintering a stainless material, namely an iron alloy comprising at least 12% by weight of chromium. The weight is provided with a V-shaped slit, in which both a steel blade acting as a clip and a blade of soldering material are positioned, before bringing the aggregate up to a temperature higher than 1100° C.

German Patent No. 101 02 321 relates to a balance weight made out of zinc or zinc alloy, which can be fixed either by means of an adhesive strip, or by means of a steel clip on which the weight is molded.

European Patent No. 1,355,084 describes balance weights made out of zinc or zinc alloy, which comprise at least a groove that allows adapting the curve of the weight depending on the radius of the rim.

International Publication No. WO2004/007993 relates to a balance weight made out of zinc or zinc alloy and connected to a steel clip. The object of WO 2004/025139 is a balance weight made out of zinc or zinc alloy, comprising a clip buried in the weight through molding, the aggregate being covered with an anti-corrosive coating.

### BRIEF SUMMARY OF THE INVENTION

This invention is aimed at providing another production method for a balance weight for vehicle wheels having the advantage, compared to the techniques described through the above-mentioned documents, of allowing a significant productivity gain.

To this end, the object of the invention is a production method for a balance weight for vehicle wheels consisting of a weight aimed at being fixed to the rim of a wheel by means of a clip. A weight is used, made through injection-molding of a zinc alloy, in the thickness of which is provided for a cavity aimed at accommodating a part of the clip. The cavity is arranged so as to allow it to accommodate and retain said part of the clip, and the latter is inserted into and made integral therewith.

According to a particular embodiment of the method according to the invention, before inserting the part of the clip into the cavity, glue is placed in the latter.

According to an additional feature of the particular embodiment of the method according to the invention, there is used a predetermined quantity of glue, namely such that during the insertion of the clip into the cavity, said glue raises along the walls of the cavity so as to ensure a better gluing and a faster drying.

Furthermore, the invention also refers to a balance weight resulting from the implementation of such a method, which is characterized in that it consists of an injected weight made out of zinc alloy and of a steel clip. The steel clip is fixed to said weight through insertion into a cavity provided for this purpose in the thickness of said weight and retained in place by gluing.

According to a second particular embodiment of the method according to the invention, before inserting the part of the clip into the cavity, the cavity is configured to allow making the clip integral through snapping-in, during said insertion. The part of the clip inserted into said cavity comprises means capable of cooperating with the configuration conferred to said cavity.

According to an additional feature of the second particular embodiment of the method according to the invention, there is provided, in at least one of the walls of the cavity, at least one secondary cavity. A protrusion is on the part of the clip to be inserted and is aimed at cooperating with the clip, after insertion.

The invention also refers to a balance weight resulting from the implementation of such a method, which is characterized in that it consists of an injection-molded weight made out of zinc alloy and of a steel clip. The clip is inserted against said weight through insertion into a cavity provided for this purpose in the thickness of said weight and retained in place by snapping-in.

The advantages and features of the method according to the invention will appear more clearly from the following description, which refers to the attached drawing, which represents a non-restrictive embodiment of it.

### BRIEF DESCRIPTION OF THE SEVERAL VIEWS OF THE DRAWINGS

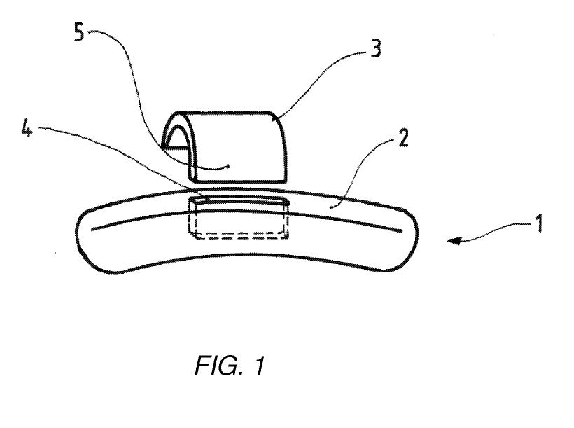

In the attached drawing, the single FIG. 1 represents a schematic prospective and exploded view of a particular embodiment of a balance weight according to the invention.

### DETAILED DESCRIPTION OF THE INVENTION

The object of this invention is a production method for balance weights 1 for vehicle wheels, each consisting of a weight 2 aimed at being fixed to the rim, not shown, of a wheel by means of a clip 3.

According to the invention, such a method contemplates providing a cavity 4, in the thickness of said weight 2, being aimed at accommodating a part 5 of the clip 3. Glue is then deposited in the cavity 4, so as to insert the part 5 and to fix the clip 3 by gluing.

Advantageously, according to a feature particular to the invention, there is used an injection-molded weight 2 made out of zinc alloy, which avoids the problems related to the use of lead, both in environmental terms and in terms of corrosion. Advantageously, the weight 2 is made out of Zamak™, a zinc alloy.

Another feature of the method according to the invention contemplates use of a clip 3 made out of steel. Indeed, steel has the advantage of having both a good mechanical stability and high elasticity, while remaining cheap.

Furthermore, it is also contemplated to make the cavity 4 in the thickness of said weight 2, so that it has final dimensions and a form capable of leading to an insertion as fit as possible of the part 5 of the clip 3.

Moreover, thanks to the use of a predetermined quantity of glue, aimed at allowing it to rise along the walls of the cavity 4, this method allows ensuring a faster drying and a perfect gluing, in order to achieve balance weights capable of long-lastingly withstanding the physical vibrations and other constraints, which they are likely to be subjected to once fitted on a vehicle wheel.

According to another embodiment, not shown, of the method according to the invention, making the clip 3 integral with the weight 2 is achieved through snapping-in and not through gluing. It is thus possible to provide, for example through machining, in at least one of the walls of the cavity 4. For a secondary cavity, which includes a protrusion that part 5 of the clip 3 includes is aimed at cooperating with the secondary cavity, after insertion.

1. Production method for a balance weight for vehicle wheels the weight being fixed to a rim of a wheel by a clip, the method comprising:
making the weight through injection-molding of a zinc alloy, the weight having a thickness for forming a cavity able to accommodate a part of said clip; and
arranging said cavity to accommodate and retain said part of said clip to be inserted, said clip being inserted into and made integral with said cavity.

2. Production method according to claim 1, wherein said clip is a steel clip.

3. Production method according to claim 1, wherein said cavity has dimensions and a form for insertion as fit as possible for said clip.

4. Production method according to claim 1, further comprising the step of:
depositing glue in said cavity before insertion of said part of said clip into said cavity.

5. Production method according to claim 4, wherein said glue has a predetermined quantity of glue, such that said glue spreads along walls of said cavity during insertion of said clip into said cavity, ensuring gluing and a faster drying.

6. Production method according to claim 1, further comprising the step of:
making said cavity and said clip integral through snapping-in before inserting said part of said clip into said cavity, said part of said clip inserted into said cavity comprising means for cooperating with configuration conferred to said cavity.

7. Production method according to claim 6, further comprising the step of:
forming at least one secondary cavity in at least one wall of said cavity, said part of said clip to be inserted having a protrusion cooperative with said secondary cavity, after insertion.

8. Balance weight, resulting from the production method according to claim 1, the weight comprising:
an injection-molded weight of zinc alloy; and
a steel clip, being fixed to the weight through insertion into a cavity provided for in a thickness of the weight, said clip being retained in place by snapping-in.

9. Balance weight resulting from the production method according to claim 6, the weight comprising:
an injection-molded weight of zinc alloy; and
a steel clip, being fixed to the weight through insertion into a cavity provided for in a thickness of the weight, said clip being retained in place by snapping-in.

10. Production method according to claim 1, wherein said zinc alloy, is comprising of Zamak™.
